(19) United States
(12) Patent Application Publication
(10) Pub. No.: US 2018/0330595 A1
(43) Pub. Date: Nov. 15, 2018

(54) CONFINED SPACE FAILSAFE ACCESS SYSTEM

(71) Applicant: Robert Levine, Port Jefferson, NY (US)

(72) Inventor: Robert Levine, Port Jefferson, NY (US)

(21) Appl. No.: 15/971,795

(22) Filed: May 4, 2018

Related U.S. Application Data
(60) Provisional application No. 62/505,636, filed on May 12, 2017.

(51) Int. Cl. G08B 21/14; G08B 17/10; G08B 27/00; G08B 17/12; G08B 25/14

(52) U.S. Cl. CPC G08B 21/14; G08B 17/10; G08B 25/14; G08B 17/125; G08B 27/005

(57) ABSTRACT

A method and safety device for use in accessing confined spaces that incorporates atmospheric safety monitoring and alarm annunciation into a physical access device/mechanism for the purpose of preventing the human confined space entrant from entering a confined space containing a hazardous atmosphere.

### CROSS-REFERENCE TO RELATED APPLICATIONS

This application claims benefit under 35 USC § 119(e) of provisional application No. 62/505,636 filed May 12, 2017. The '636 application is incorporated, by reference herein.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the field of occupational safety as it applies to Confined spaces. Confined space entries that are safe and United States Occupational Safety and Health Administration (OSHA) compliant require personnel to meter the atmosphere prior to entry to ensure that it poses no danger to the entrant. Other countries have similar regulatory organizations and requirements.

Many infrastructure and industrial facilities have confined spaces that must be accessed on a routine basis to support or maintain operations. Many safety regulatory agencies around the world have similar definitions to define what constitutes a confined space. In the United States, OSHA defines a confined space as, (Excerpted from OSHA 3138-01R 2004):

Many workplaces contain spaces that are considered to be “confined” because their configurations hinder the activities of employees who must enter into, work in or exit from them. In many instances, employees who work in confined spaces also face increased risk of exposure to serious physical injury from hazards such as entrapment, engulfment and hazardous atmospheric conditions. Confinement itself may pose entrapment hazards and work in confined spaces may keep employees closer to hazards such as machinery components than they would be otherwise. For example, confinement limited access and restricted airflow can result in hazardous conditions that would not normally arise in an open workplace.

The terms “permit-required confined space” and “permit space” refer to spaces that meet OSHA's definition of a “confined space” and contain health or safety hazards. For this reason, OSHA requires workers to have a permit to enter these spaces.

By definition, a confined space:
Is large enough for an employee to enter fully and perform assigned work;
Is not designed for continuous occupancy by the employee; and
Has a limited or restricted means of entry or exit. These spaces may include underground vaults, tanks, storage bins, pits and diked areas, vessels, silos and other similar areas.

By definition, a permit-required confined space has one or more of these characteristics:
Contains or has the potential to contain a hazardous atmosphere;
Contains a material with the potential to engulf someone who enters the space;
Has an internal configuration that might cause an entrant to be trapped or asphyxiated by inwardly converging walls or by a 3 floor that slopes downward and tapers to a smaller cross section; and/or
Contains any other recognized serious safety or health hazards

Confined spaces are inherently dangerous to workers. Many industrial accidents in confined spaces result in death and injury of exposure to other hazards that may not be obvious prior to entry. Accidents in confined spaces have led to secondary deaths or injuries to workers who try and rush to the aid of a fellow worker and fall victim to a hidden hazard. It is estimated that up to 100 work-related deaths in the United States occur on an annual basis from accidents related to operations conducted within these dangerous environments.

As a result of the dangers associated with confined space entry, OSHA and other regulatory agencies have mandated that certain procedures be followed when an individual must enter these locations. These procedures are intended to reduce the risk of injury to an individual that must enter the space.

Atmospheric testing of confined spaces prior to entry are critical to safe entry of many confined spaces. One of the primary sources of death and injury to workers involved in confined space entry operations is asphyxiation. Proper safety protocols have been defined by OSHA that mandates that the atmosphere is tested with certified equipment and for a sufficient length of time by an individual who is appropriately trained on its operation.
Excerpts from an OSHA fact sheet, (Title 29 Code of Federal Regulations 1910.146, Appendix B. 2 29 CFR 1910.146(c)(5)(ii)(C) and (d)(5)(iii)), on gas metering in advance of confined space entry is as follows:
Atmospheric testing is required for two distinct purposes: evaluation of the hazards of the permit space and verification that acceptable conditions exist for entry into that space.

Evaluation Testing:
The atmosphere within a confined space must be tested using equipment that is designed to detect the chemicals that may be present at levels that are well below the defined exposure limits.

Evaluation testing is done to:
determine what chemical hazards are or may become present in the space's atmosphere, and
identify what steps must be followed and what conditions must be met to ensure that atmospheric conditions are sale for a worker to enter the space.

Verification Testing:
Before a permit space that may have a hazardous atmosphere can be entered, the atmosphere must be tested using the steps identified on the permit (developed during evaluation testing). Verification testing is done to make sure that the chemical hazards that may be present are below the levels necessary for safe entry, and that they meet the conditions identified on the permit. Test the atmosphere in the following order:
(1) for oxygen,
(2) for combustible gases, and then
(3) for toxic gases and vapors.

### Problem Defined:

Atmospheric testing in a confined space is usually conducted using a multi-gas meter that is specifically designed to test for such atmospheric conditions as Oxygen levels, Hydrogen Sulfide levels, Carbon Monoxide levels and LEL, (lower explosive levels of combustible gases). This suitable regulatory agency compliant device will be referred to in this document as an atmospheric sensor/meter.

In some instances, injuries and fatalities will occur when individuals enter into a confined space without the appropriate training or access to appropriate safety equipment and do not take proper measures of metering the atmosphere prior to entry. In these situations, it is easy to understand how an unnecessary death or injury could result.

Unfortunately, there are also confined space accidents that occur with individuals who have been trained and have access to vital safety and monitoring equipment. In the majority of these cases, it is the entrant who will accidently or willfully neglect to properly test the atmosphere of the confined space prior to entry. As a result of these careless and dangerous acts by those individuals and despite confined space entry training; knowledge of regulatory safety agency regulations; knowledge of company safety policy mandating atmospheric testing prior to entry and access to appropriate atmospheric metering technology fatalities and injuries still occur in the workplace due to asphyxiation in confined spaces.

When a worker neglects to meter the atmosphere, he is taking unnecessary chances with his health and well-being and increases the potential liability of his employers. An employee who engages in this breach of safety protocol may often repeat his advance atmospheric testing omission many times with increasing confidence, until it is too late and there is an accident. In most instances, the atmosphere will be sufficiently safe for human life and the employee will suffer no permanent ill consequences. His risky behavior may go unnoticed by supervisory staff until he enters a confined space that has an atmosphere that will not support human life and there is a death or serious injury.

### BRIEF SUMMARY OF THE INVENTION

A method of preventing access to a dangerous confined space atmospheric environment is herein described. The unique safety feature of this invention is that it forces a safety reading of a confined space atmosphere and will issue a preemptive alarm in advance of entry. This is accomplished by marrying the atmospheric meter-alarm system to the mechanism that is utilized to facilitate ingress and egress to and from the confined space. This alarm would remove significant if not all doubt of the user that physical entrance to the confirmed space is life threatening from a dangerous atmosphere in advance of entry. Further the testing and alarm will indicate to surrounding personnel and facilities management, that critical safety procedures are not being followed, acting as a deterrent to the operator/entrant to not maintaining established safety producers. This protection is accomplished as a natural consequence of facilitating the entrant access to the space.

### BRIEF DESCRIPTION OF THE DRAWINGS

The present invention can best be understood in connection with the accompanying drawings. It is noted that the invention is not limited to the precise embodiments shown in the drawings in which the drawing Figures are described as follows:

FIG. 1 is an overall perspective view in partial cutaway, of the basic invention installed into a typical confined space with atmospheric sensor and Alarm Status Annunciator Module (ASAM) shown mounted to the entrance assembly, in this example, a ladder.

FIG. 2 is a perspective view depicting the entrance assembly in its dormant storage orientation in the general vicinity of the confined space entrance.

FIG. 3 is a block diagram of the system configured with the Alarm Status Annunciator Module (ASAM) and the gas sensor/meter mounted directly to the entrance assembly with a wireless motor interface, wherein optional accessories are also shown.

FIG. 3A is a block diagram of the system configured with the Alarm System Annunciator Module (ASAM) and the gas sensor/meter mounted directly to the entrance assembly, with a wired meter interface, wherein optional accessories are also shown.

FIG. 4 is an overall perspective view in partial cutaway of an enhanced version of invention installed into a typical confined space with multiple atmospheric sensors and Alarm Status Annunciator Module (ASAM), Video camera and integrated work light shown mounted to is the entrance assembly, in this example, a ladder.

FIG. 5 is an overall perspective view in partial cutaway of another example of an entrance device, in this example, a cable system, with an atmospheric sensor and Alarm Status Annunciator Module (ASAM) shown mounted.

FIG. 6 is a close-up detail view showing the Alarm Status Annunciator Module (ASAM).

FIG. 7 is a diagrammatic view showing the remote, networked communication device receiving an alarm from the confined space access system.

FIG. 8 is a flow chart showing a basic logic diagram for programming the Alarm Status Annunciator Module (ASAM) microprocessor or the Active/Dormant Sensor Module (ADM).

FIG. 9 is a perspective view in partial cutaway showing an alternate configuration of the invention installed into a typical confined space, where the Status Annunciator Module (ASAM) is mounted separately from the entrance assembly; in this case a ladder, and multiple atmospheric sensors and active/dormant module (ADM) are mounted to the entrance assembly.

FIG. 10 is a block diagram of the system showing a typical system utilizing the Active/Dormant Sensor Module (ADM) to relay the data to a remote Alarm Status Annunciator Module (ASAM).

FIG. 11 is a close-up detail view showing the Active/Dormant Sensor Module (ADM).

FIG. 12 is a diagrammatic view showing the possible data path between the alarm status annunciator module, (ASAM), the active/dormant Module (ADM), and the gas sensor/meter.

### DETAILED DESCRIPTION OF THE INVENTION

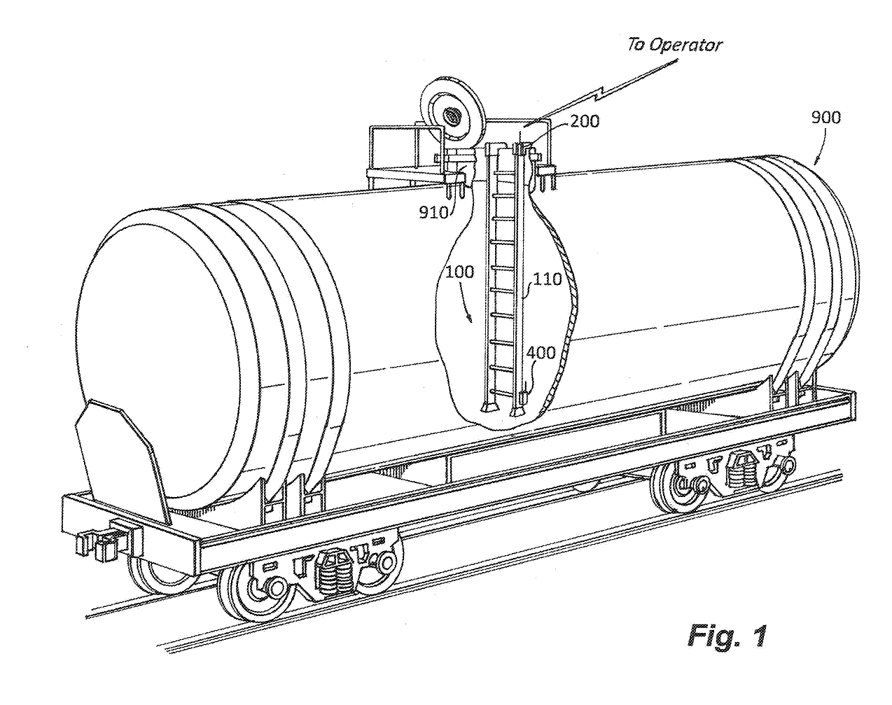

FIG. 1 shows a confined space 900, with an entrance port 910 into which an entrance assembly 100 has been inserted. The confined space 900 here is depicted here as a mobile tank, but could be any number of different confined spaces including fixed or mobile tanks, vaults, utility spaces, or any confined space meeting the definition previously described. The entrance assembly 100 comprises a means to physically enter and exit the confined space 900, in this case shown as a ladder 110, one or more gas sensor or meters 400, and an alarm status annunciator module, (ASAM) 200. A suitable regulatory agency compliant gas sensor or meter 400 tests the atmosphere within the confined space 900 before the human operator can enter the confined space. The status of the gas sensor or meter 400 is communicated electronically by wire or a wireless means to the alarm status annunciator module, (ASAM) 200, which in turn communicates to the operator and other parties whether the environment is safe or unsafe or indeterminate for entry, by means a visual indication and audible single. As an example, a safe condition may be indicated with a steady green light 210G, unsafe with a red strobe 210R and audible siren 220, and indeterminate with a yellow light 210Y and intermittent audible sound 220. Voice annunciation can be added to specify a specific threat condition, urgency, etc. Specific indicators can be customized for specific safety conventions, operating conditions, etc.

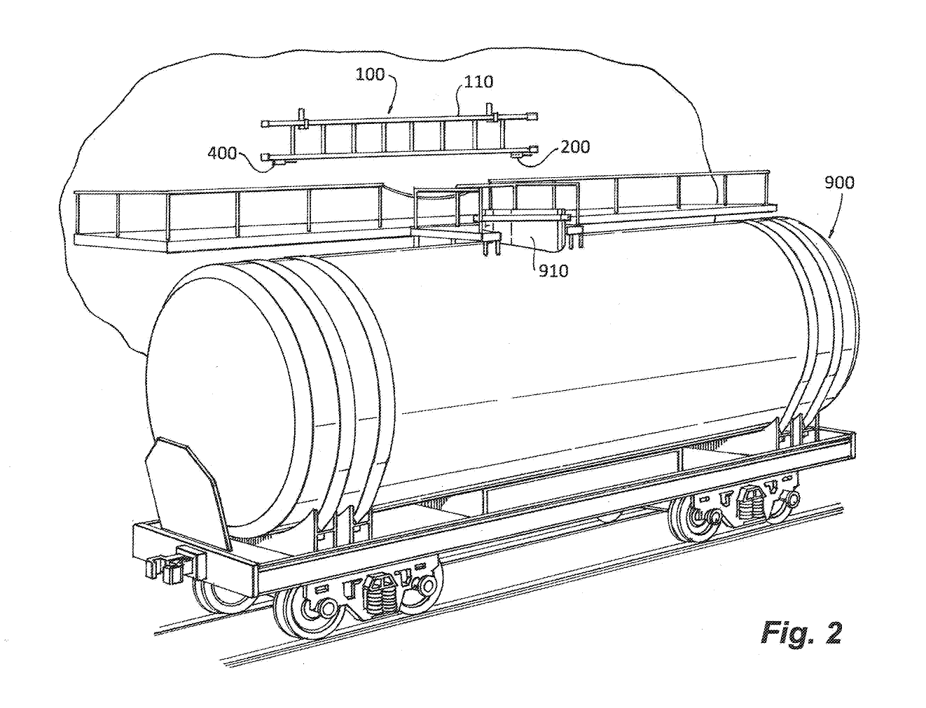

FIG. 2 shows the entrance assembly 100 in a stored or dormant mode in convenient proximity to a typical confined space entrance 910.

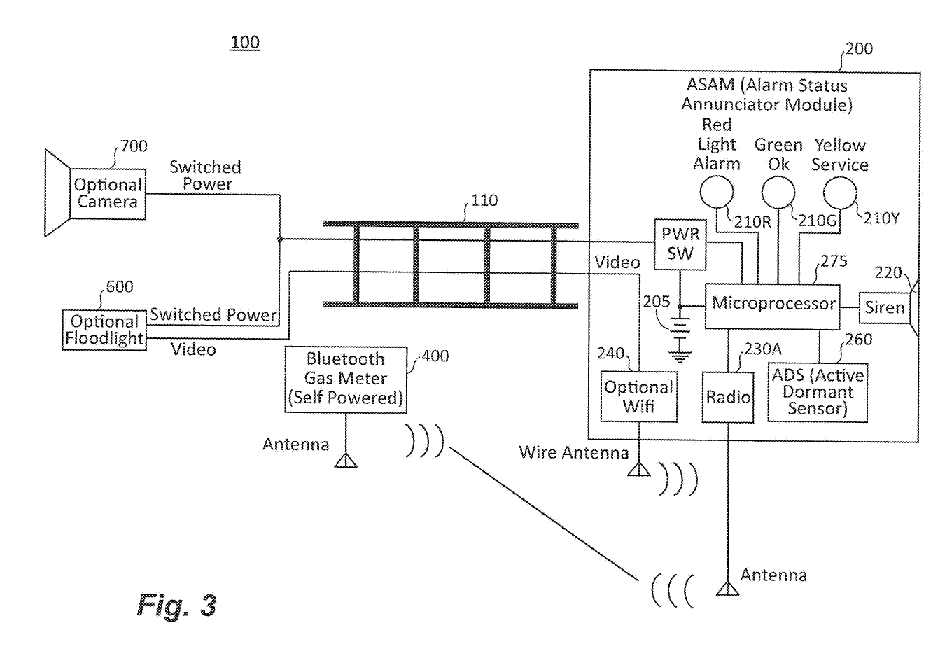

FIGS. 3 and 3A depict typical system block diagrams of the overall entrance assembly 100 including a number of optional components. In its simplest form the entrance assembly 100 comprises the ladder 110 or other device that facilitates physical entry into the confined space 900, with a gas sensor or meter 400 and alarm status annunciator module, (ASAM) 200 attached. In its simplest form the gas sensor or meter 400 and alarm status annunciator module, (ASAM) 200 are wired together communicate with each other as shown in FIG. 3A. The alarm status annunciator module, (ASAM) 200 could be used to directly power the gas sensor or meter 400 and control its on/off state, thus simplifying power management for both devices.

Options include a work light 600, video camera sensor 700 to remotely monitor the working in the confined space 900, and various wireless telemetry for communicating to sensors and communicating to remote monitoring locations by WiFi, Bluetooth, ZigBee or other similar wireless communication protocols.

Depending on the physical geometry of the confined space 900 and the appropriate entrance device 110 it may be more practical to use a self-powered gas sensor or meter 400 with a wireless connection to the alarm status annunciator module, (ASAM) 200 for more flexibility as shown in FIG. 3. This connection could be any of the wireless options previously described. Further breakdown and description of the alarm status annunciator module, (ASAM) 200 are described below. The alarm status annunciator module, (ASAM) 200 can act as a wireless repeater to negate the effect of a metal confined space 900 enclosure, such as a steel tank, that may restrict or attenuate its output signal level of the transmitter that is inserted into this space. This wireless repeater will allow wireless data transmitted from a wireless data source, using a wireless protocol, such as, but not limited to, Bluetooth or Wi-Fi, to devices outside of the space in a reliable fashion.

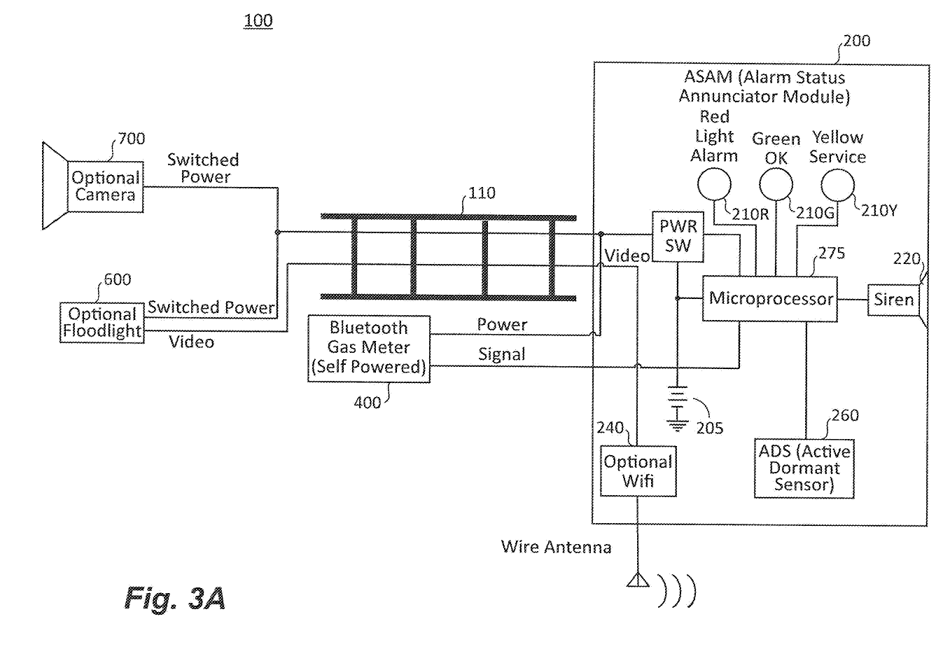

FIG. 4 shows a version of the entrance assembly 100 with multiple gas sensor or meters 400, optional video sensor 600 and integrated work light 700. The work light 600 and the video camera sensor 700 can optionally be combined into a single enclosure.

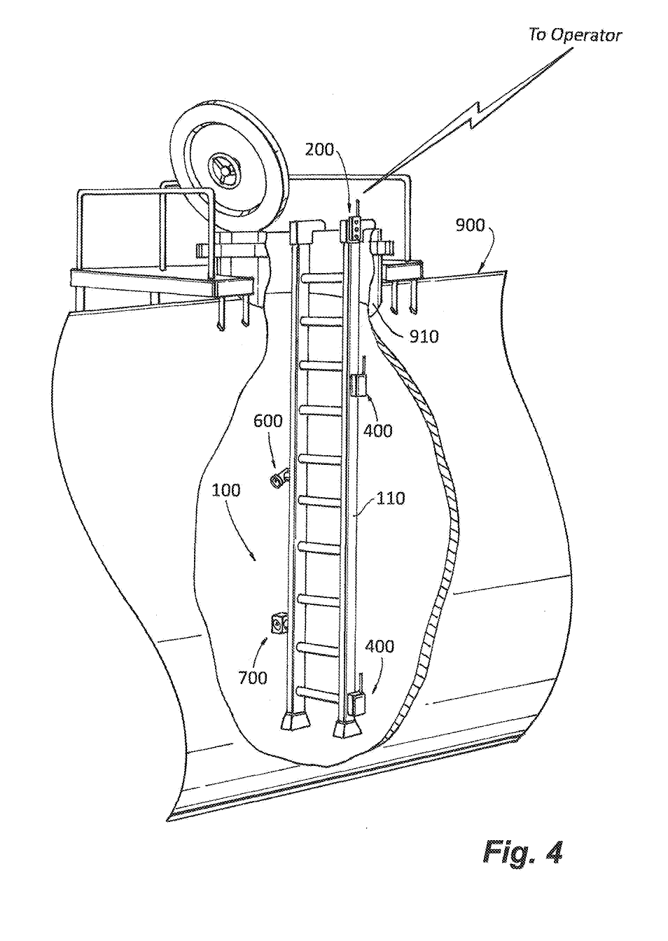

FIG. 5 shows an alternate entrance assembly 100, in this case built around a cable based entrance assembly 120. This also shows how a wireless connection between the gas sensor or meter 400 and the alarm status annunciator module, (ASAM) 200 might be more practical. As with the ladder based entrance assembly, the cable based entrance assembly must be configured such that the sampling point of the gas sensor or meter 400 enters and reports the atmospheric condition of the confined space before the entrant reaches a potentially unsafe position within the confined space.

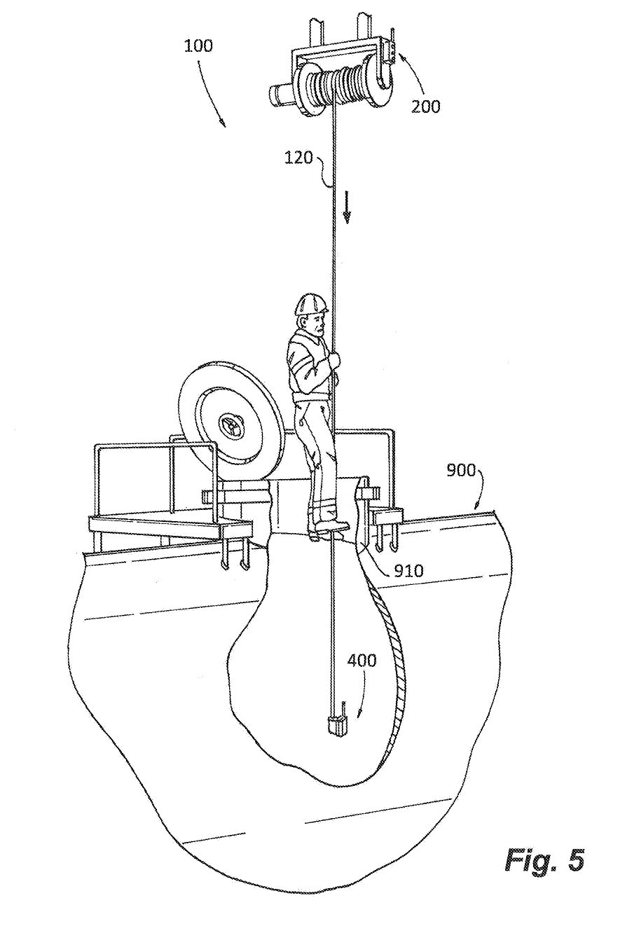

FIG. 6 along with the alarm status annunciator module, (ASAI) 200 portion of the block diagram in FIG. 3 describes the alarm status annunciator module, (ASAM) 200. The alarm status annunciator module, (ASAM) 200 comprises a power source 205 which can be a rechargeable battery and or a field replaceable long life battery. Optionally, the rechargeable battery can be configured to charge when the entrance assembly 100 is stored in it dormant position when not in use. Included in the basic version is a microprocessor for receiving sensor data including from the active/dormant sensor 260 and the gas sensor/meter 400 and initiating status indications and alarms as appropriate to visual alarms or indicators 210R, 210G, 210Y, an audible alarm 220, and optionally, the alarm status annunciator module, (ASAM) 200 can incorporate wireless communications such as WiFi 240 and/or Bluetooth 230 to communicate with sensors and network.

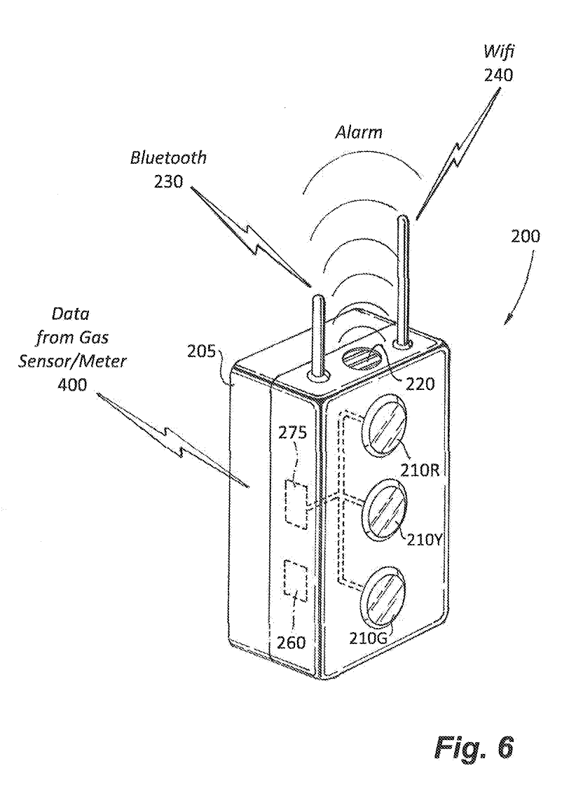

FIG. 7 depicts a monitoring station computer 280 which receives telemetry from the entrance assembly alarm status annunciator module, (ASAM) 200. This telemetry would typically be through a wireless access point and/or wired network connection. This monitoring station would be utilized to provide alerts to a monitoring person outside of the confined space area. The monitoring station computer 280 would run software that receives and interprets the telemetry from the confined space entry system to log data and provide alerts from each of multiple confined space entry systems 100 on the network. The monitoring station 280 can be provided in the form of a PC console 280a, tablet 280b or mobile device (such as a smartphone 280c or wearable mobile device 280d, i.e., a smart watch)

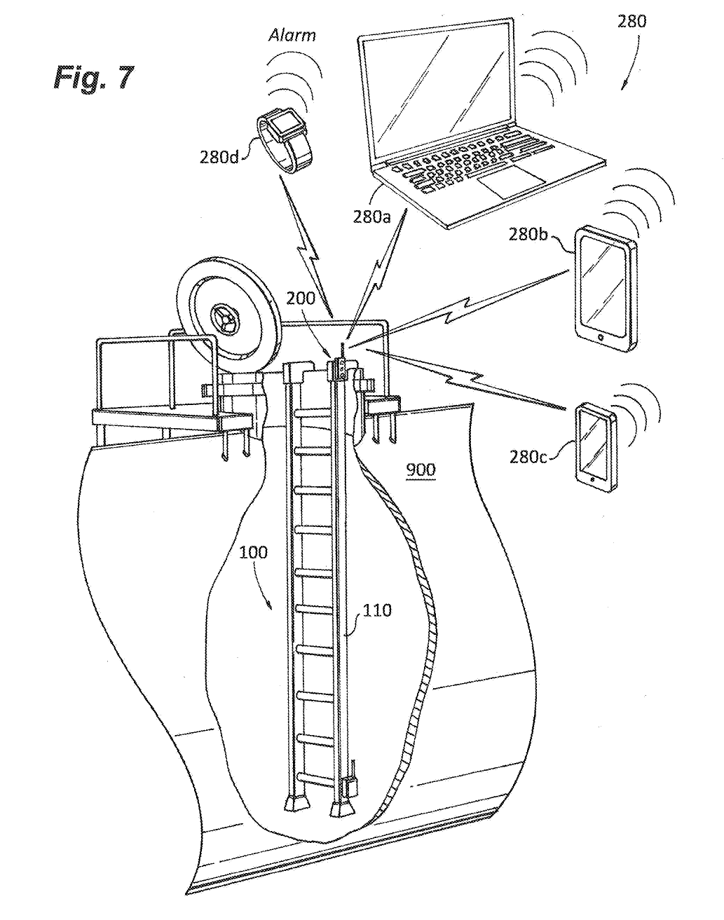

FIG. 8 shows a basic logic diagram for the program running on the alarm status annunciator module, (ASAM) 200 microprocessor 270. Many other functions that enhance the functionality of the overall system can also be included here.

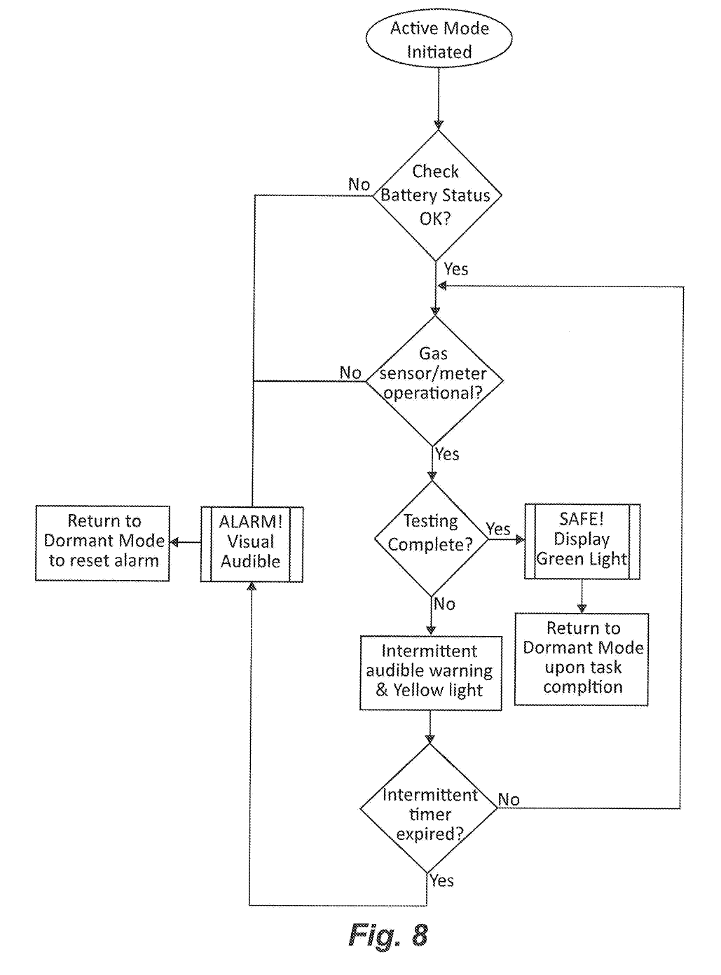

FIG. 9 shows an alternate embodiment of the system, where the alarm status annunciator module, (ASAM) 200 is located in a fixed position in proximity to the confined space entrance port 910 and an active/dormant Module (ADM) 300 is secured to the entrance assembly 100 instead. In this case the active/dormant sensor 260 is moved from the alarm status annunciator module, (ASAM) 200 in the previous description to the active/dormant Module (ADM) 300. This embodiment allows the alarm status annunciator module, (ASAM) 200 to be large, with more robust enunciators, wired into mains power, and optionally connected to a wired network while more clearly able to broadcast alarms and status to the surrounding area than as necessitated by smaller, battery powered alarm status annunciator module, (ASAM) 200 located directly onto the entrance assembly 100 as in the prior described embodiment. The active/dormant Module (ADM) 300 can be kept small with low power consumption required and is used primarily to wirelessly transmit the active/dormant sensor 260 information to the remotely located active/dormant sensor 260. Optionally the active/dormant Module (ADM) 300 can be configured to transmit status from the gas sensor/meter 400 to the remote alarm status annunciator module, (ASAM) 200. Since the alarm status annunciator module, (ASAM) 200 and the active/dormant Module (ADM) 300 contain a microprocessor and wireless communications, the sensor telemetry and warning logic tasks can be split between the two modules in many ways to maximize efficiency and fail safe operation of the overall system.

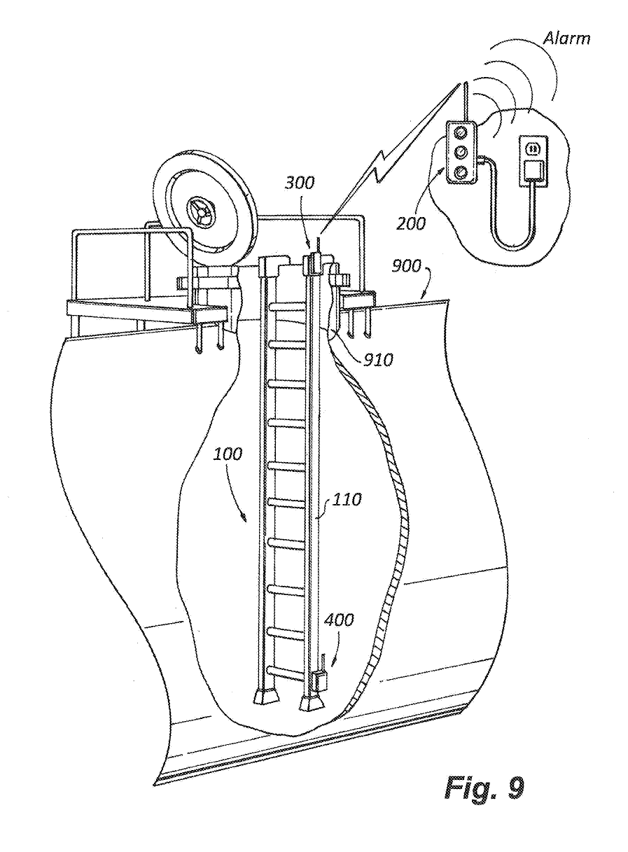

FIG. 10 is a block diagram of the alternate embodiment of the system. Here, the active/dormant Module (ADM) 300 is part of the physical entrance assembly 100, and the alarm status annunciator module, (ASAM) 200 is located physically separate from the entrance assembly 100 at a nearby fixed location.

The details of features in the overall system are otherwise the same as described in FIG. 3.

Options shown include a work light 600, video camera sensor 700 to remotely monitor the working in the confined space 900, and various wireless telemetry for communicating to sensors and communicating to remote monitoring locations by WiFi, Bluetooth, ZigBee or other similar wireless communication protocols.

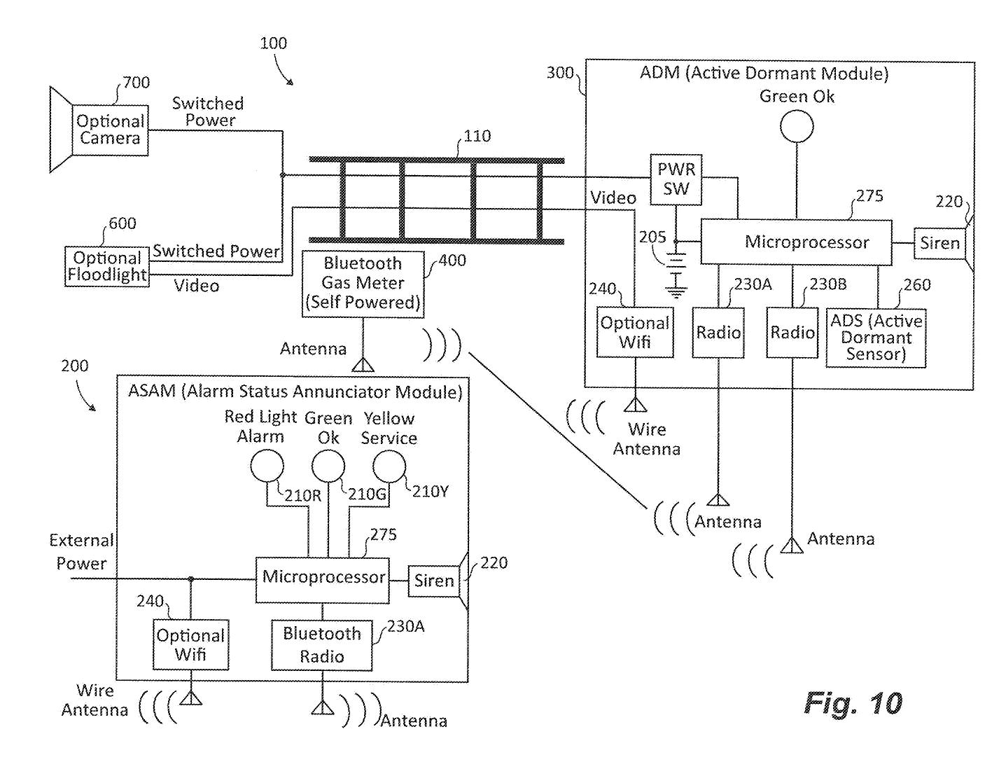

FIG. 11 along with the active/dormant Module (ADM) 300 portion of the block diagram in FIG. 10 describes the active/dormant Module (ADM) 300. The active/dormant Module (ADM) 300 contains a power source 205 which can be a rechargeable battery and or a field replaceable long life battery. Optionally, the rechargeable battery can be configured to charge when the entrance assembly 100 is stored in its dormant position when not in use. Included in the basic version is a microprocessor for receiving sensor data including from the active/dormant sensor 260, optional video sensor 700 and the gas sensor/meter 400 and wirelessly transmitting the status of each to the alarm status annunciator module, (ASAM) 200. Optionally, a wireless version of the gas sensor/meter 400 could also transmit its status directly to the alarm status annunciator module, (ASAM) 200 assuming its wireless capability can reliably communicate with the alarm status annunciator module, (ASAM) 200 when the entrance assembly 100 is installed in its active position. This option would depend on the details of the physical geometry of the overall system and the capabilities of the wireless components.

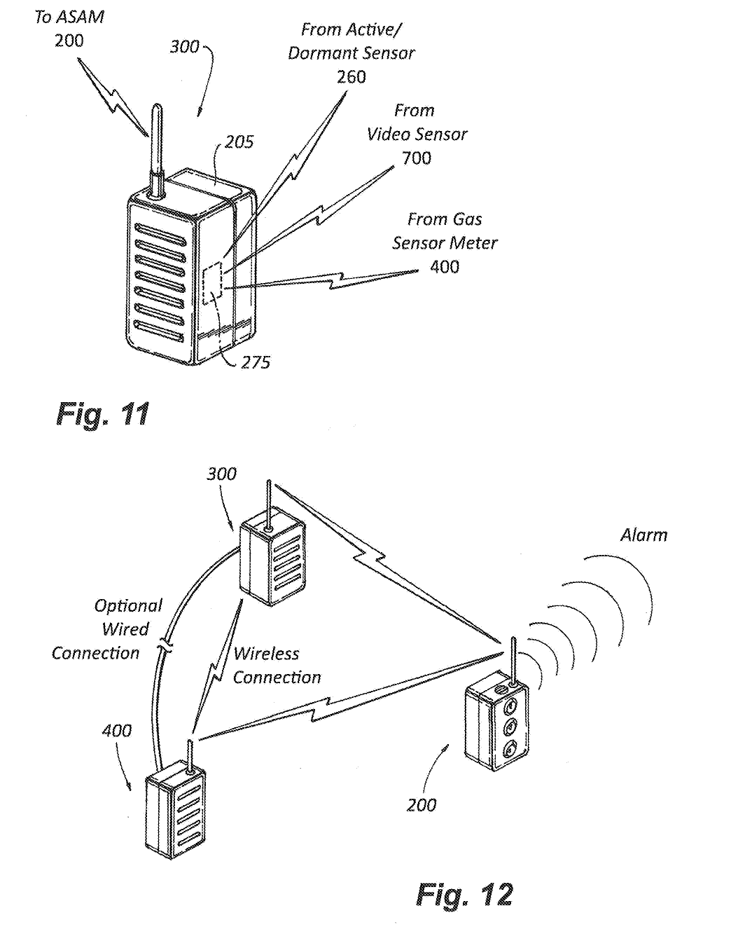

FIG. 12 shows the possible wired and wireless data paths between the alarm status annunciator module, (ASAM) 200, the active/dormant Module (ADM) 300, and the gas sensor/meter 400.

Note that the gas sensor/meter 400 can connect wirelessly (if so capable) directly to the alarm status annunciator module, (ASAM) 200, or to the active/dormant Module (ADM) 300 depending on what makes most sense giving the wireless capability of the gas sensor/meter 400 and the physical geometry of the confined space and surrounding area. The gas sensor/meter 400 can also be wired to the active/dormant Module (ADM) 300.

This method and invention is designed to prevent access into a confined space 900 that has an atmosphere that is not suitable to sustain life by generating a conspicuous alarm response when entry is initiated. It is accomplished by affixing a suitable regulatory agency compliant gas sensor or meter 400 to one end of a mechanical assembly 100 that facilitates access into and egress out of the confined space 900 by the entrant. The preferred gas sensor/meter 400 can be one of two basic types depending on the specific application and expected potential hazards. One type is self-contained and samples the atmosphere in its immediate vicinity. The other can incorporate a sampling tube to enable it to sample the atmosphere at some distance from the meter. This type of device can also effectively sample from multiple locations either by incorporating a manifold with multiple sampling tubes with multiple sampling locations, or a single sampling tube with multiple ports. This would allow sampling at more than one depth in the confined space with a single meter to take into account atmospheric stratification that could exist at different levels of the confined space due to variations in gas density. Either gas meter type requires the ability to communicate wirelessly or by wire a meter status condition including an alarm state to the system. Preferably the gas sensor or meter can also communicate its own health status including functionality of its sensors and battery charge status. The location of where the atmospheric sample is taken need not necessarily be where the meter is physically located by using a meter incorporating a sampling tube. In this case the sample is taken from the sampling point at the end of the sampling tube or from multiple sampling tubes or multiple sampling points along the length of the sampling tube. These gas meters as described are readily available in the marketplace from multiple vendors and, can be selected as required for specific features, ease of mounting and compatibility with communication with the other modules of the system.

Examples of the entrance assembly 100 include but are not limited to a cable 120, ladder 110, ramp, stairway or any other assembly or device that will facilitate physical entry in to the confined space 900. For the purpose of simplifying the system description, we refer to this mechanical assembly that facilitates access and egress as the entrance assembly 100.

The sampling point of the atmospheric sensor/meter 400 is immersed into the confined space 900 environment in advance of the entrant as a natural consequence of utilizing the entrance assembly 100. When the entrance assembly 100 is put into position, the atmospheric sensor/meter 400 sampling point will monitor the atmosphere and communicate its status using wired or wireless means to an alarm status annunciator module, (ASAM) 200, or the active/dormant Module (ADM) 300 depending on the system configuration chosen. The remote annunciators of the alarm status annunciator module, (ASAM) 200 can consist of audible alarms 220, visual alarms 210 and network, data telemetry 230, 240 for remote alerts and archival storage that an alarm event occurred though a networked computer 280.

The alarm status annunciator module, (ASAM) 200, can be mounted on the opposite end of the entrance assembly 100 or mounted/positioned in close proximity to the confined space entrance 205. In either instance, the ASAM 200 resides outside of the confined space. The ASAM 200 can indicate an alarm condition with, but not limited to, red strobe lights 210R and a high decibel audio alarm 220. Conversely, the alarm status annunciator module, (ASAM) 200 can indicate that an acceptable atmosphere exists in the space with a green light 210G, or some other type of annunciator signal. The alarm condition will be generated after the ladder is inserted into the access port 910 into the confined space 900. (i.e. hatch or manway), but before the entrant has an opportunity to enter into the space. The alarm status annunciator module, (ASAM) 200 can also record the atmospheric readings from the gas sensor/meter 400 along with a time and date stamp in a digital memory log. The alarm status annunciator module, (ASAM) 200 can also interface with a local area network to communicate overall status and alarm conditions to other individuals and locations though a networked computer 280.

The active/dormant sensor 260 function can be either incorporated into the alarm status annunciator module, (ASAM) 200 or into a remote active/dormant Module (ADM) 300 that communicates with the alarm status annunciator module ASAM 200. The entrance assembly 100 is monitored by the active/dormant sensor 260 that can indicate an operational mode or a dormant mode. This sensor need not be inserted into the confined space. An operational mode would be when the entrance assembly 100 is put into a position where it would be used to gain access into a confined space 900. This same sensor can also monitor when an individual mounts the ladder. This would indicate that the gas sensor/meter 400 should be operational and atmospheric data is representative of conditions in the confined space 900. A dormant mode would be when it is stored or otherwise not currently in use. An example of an active dormant sensor 260 could be a device that would indicate that the entrance assembly 100 is in close proximity to the tank, manway or other physical structure of the confined space 900. There are many sensor technologies that could be adapted for this purpose including, but not limited to, optical, ultrasonic, pressure, load, conduction, Hall Effect, piezo electric, and others. A simple switch could be used to change state when the entrance assembly 100 is put into an operational position and it comes into contact with the entrance way or other mechanical feature of the confined space 900. Another example could be a simple mercury switch or inclinometer that could indicate horizontal or vertical position of the ladder or other entrance assembly 100. The concept in this case being that the entrance assembly 100 would be inserted into the confined space entrance port 910 in a vertical position when operational and in a horizontal position when it is not being utilized and in its dormant mode. The alarm status annunciator module, (ASAM) 200 uses this sensor information 260 to know when to expect relevant data from an atmospheric meter/sensor and thus know when to generate an alarm. The physical location of this sensor can be located within the alarm status annunciator module ASAM 200, or the remote active/dormant Module (ADM) 300.

The operational/dormant sensor (ADS) 260 signal could be sourced from an independent system than the atmospheric sensor/meter 400 and thus could provide other status or alarm information. For example, if the operational/dormant sensor (ADS) 260 indicated an operational orientation and there was no atmospheric sensor/meter 400 data available within a timeout period, the alarm status annunciator module ASAM 200 would indicate an alarm condition to indicate that the system is not functionally operational. The alarm status annunciator module ASAM 200, could also monitor the battery condition of both the gas sensor/meter 400 and the operational/dormant sensor (ADS) 260 to generate low battery alarms. In some embodiments of the design the active/dormant sensor 260 could signal control of power to other modules in the system when it detects a dormant state, with the intention of reducing power to modules to conserve battery life when not in use. The alarm status annunciator module ASAM 200 could also monitor its own battery level as well as the battery condition of both the atmospheric sensor/meter 400 and the active/dormant sensor 260 to generate low battery alarms.

This active/dormant sensor 260 assembly can be integrated into the alarm status annunciator module, (ASAM) 200, or it can be configured as a separate active/dormant module (ADM) 300 that has its own power source and transmits its status to the remotely located alarm status annunciator module (ASAM) 200 using a wireless data transmission such as Bluetooth 230, ZigBee 230, Wi-Fi 240 or other standard or proprietary wireless data transmission protocol.

In general, the system is designed to be exceedingly difficult to defeat by the operator without causing permanent and obvious damage to the system so as to deter operators from temporarily cheating the system against their and their employer's best interests. In all situations, the alarm status annunciator module, (ASAM) 200, will indicate whether the system is functioning with an indication for Alarm 210R, Safe 210G and Indeterminate 210Y visual indicators. Tamper resistant designs will be utilized for any sensitive or programmable portions of the electro-mechanical assembly including such mechanisms as metal enclosed wire runs, anti-tamper assembly hardware, as well as safeguards against other obvious methods that might be utilized with the intention of circumventing the intention of the invention device.

Many confined spaces 900 require an individual to enter through a hatch or manway 910 and descend down into the space using a portable ladder 110. Examples of this process can be seen when examining bulk transportation operations that utilize rail tankers, hopper cars, ISO tanks or tank truck carriers. Many other confined spaces 900 can utilize this invention and method and use of these examples should in no way be considered a limitation to the use of the invention.

When it is necessary for an individual to enter into the tank for an inspection or a maintenance operation, they must open a hatch, test the atmosphere, insert a ladder, or other type of assembly that helps facilitate access into and egress out of the space and climb down into the tank area which is a confined space. This could include, but not be limited to, a ladder placed into a large vessel, tank or vault and mounted on the lip or flange of a manway, or hatch that opens into the vessel, tank or vault. In many instances, this is the only way that an individual can physically enter or exit the space. It is assumed that the atmosphere of the tank is monitored prior to entry by the entrant to ensure that it is safe.

By integrating atmospheric sensors with remote annunciation and telemetry onto the ladder, or any other device that facilitates entry, it would be impossible for an individual to enter into a confined space without the benefit of prior knowledge on the condition of the atmosphere. Even if the individual neglects to meter the atmosphere prior to entry, to ensure that it is safe, the atmospheric sensors on the entrance assembly that is inserted into the confined space will report on an unsafe atmosphere in advance of entry.

An application example would be as follows:

An operator needs to conduct a maintenance/repair operation inside of a truck carrier tank 900. The operator opens the batch covering the manway 910. This is when the atmosphere of the tank should be tested. If the atmosphere is not safe, then no further steps should be taken by the operator to enter the space. If the atmosphere is safe, entrance assembly 100 is used to allow the entrant to climb down into the confined space 900, in this example a tank, to conduct business. The entrance assembly 100 is stored on the wail in a horizontal position as shown in FIG. 2. The alarm status annunciator module, (ASAM) 200, is reading the active/dormant sensor 260 and indicates that the ladder is inactive or dormant.

The system integrity will be failsafe by incorporating several features to ensure that the system is operating within normal limits. The monitoring of the battery life for active/dormant sensor 260 to make sure that the battery is not close to its lower operational limit of charge. If the battery is low, then an alarm event will be triggered to notify the operator that the system needs attention and the battery should be replaced or recharged. The dormant mode can also indicate to the alarm status annunciator module, (ASAM) 200 that the gas sensor/meter 400 should be powered off If gas sensor/meter 400 readings are still detected, the; the operator has left the atmospheric meter/monitor powered on and will be draining the battery unnecessarily. The alarm status annunciator module, (ASAM) 200 can alert the operator to shut off the gas sensor/meter 400 to preserve battery life or the system could automatically shut off the necessary components not required in the dormant mode. The operator removes the entrance assembly 100 from its horizontal storage location and inserts it vertically into the open manway (entrance port 910) to allow access into the tank (confined space 900). The active/dormant sensor 260 now indicates that the ladder is in an operational configuration. The alarm status annunciator module, (ASAM) 200 will log the time and date that the entrance assembly 100 was placed in an operational configuration. When the entrance assembly 100 is placed in this position, the alarm status annunciator module, (ASAM) 200 will now try and communicate with the gas sensor/meter 400 on the end of the entrance assembly 100. If it cannot establish communications with the gas sensor/meter 400 it will go into an equipment failure alarm mode. This alarm will now alert the operator that no further action should be taken until the equipment is made operational. This may be a simple matter of turning on the gas sensor/meter 400 that was accidently left off, or changing a discharged battery. If communications are established the alarm status annunciator module, (ASAM) 200 will now monitor atmospheric conditions from the gas sensor/meter 400 and indicate safe conditions with a green annunciator light 210G. If data is returned that indicates an unsafe condition, the alarm status annunciator module, (ASAM) 200 will go into an alarm mode, sound a high decibel alarm 220 and activate the alarm light indicators 210R. If safety protocols dictate that an individual must test the atmosphere of the confined space before the entrance assembly 100 is inserted, then this alarm is an indication of a procedural error on the part of the employee and an accident was averted.

The alarm status annunciator module, (ASAM) 200 data can also be transmitted to a networked monitor 280 in the form of a PC console 280a, tablet 280b or mobile device (such as a smartphone 280c or wearable mobile device 280d, i.e., a smart watch) via a network where the status of multiple locations can be displayed. In some instances, it may be necessary to place a wireless repeater on the opposite end of the ladder to allow the wireless signal to be transmitted outside of the tank. This repeater would be incorporated into the alarm status annunciator module, (ASAM) 200 or active/dormant Module (ADM) 300. Remote antennas can also be used to allow proper signal strength and is received for all of the wireless information. See FIG. 7.

Other features could be integrated onto the ladder to increase its capability—such as a video camera 700 that can allow others to observe the entrant inside of the confined space, as well as illuminators or an integrated work light 600 that can serve to light up the space and allow an entrant to see.

If a safety protocol is adopted that the entrant must meter the atmosphere of the confined space prior to inserting the ladder, then the system alarm serves a dual function. If the entrance assembly 100 alarm initiates—it not only will alert the employee of the problem before entry and potentially save his life, it will also inform management that this individual has not tested the atmosphere in advance of entry as per established procedures. They will now be aware that this worker is operating in an unsafe manner that is not compliant with regulatory agency mandates and the employee's training. As a result of this procedural omission, the entrant is putting themselves and their employers at risk of potential negative consequences. Action can be taken by management in advance of an accident to mitigate a hazardous action by the employee with either retraining or termination.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

I claim:

1. A confined space failsafe access system comprising:
said confined space having an entrance port;
apparatus to facilitate entry of a worker into said confined space extending through said entrance port into said confined space;
a first gas detecting sensor within said confined space for detecting a dangerous condition, said sensor mounted on a lower portion of said entry apparatus;
an alarm status annunciator module outside of said confined space communicating with said sensor for broadcasting whether environment within said confined space is safe or unsafe for entry by said worker; and,
a second active dormant sensor with feedback to monitor active access by an individual into said confined space.

2. The access system of claim 1 in which said annunciator module directs power to said first gas detecting sensor and controls an on/off state of said first gas detecting sensor thereby simplifying power management of both said first gas detecting sensor and said annunciator module.

3. The access system of claim 1 in which said gas detecting sensor is powered from and with a wired data connection to said annunciator module, said annunciator module functioning as a repeater of said first gas detecting sensor data from within said confined space, allowing wireless data to be transmitted from wired data source from outside of said confined space.

4. The access system of claim 1, in which said first gas detecting sensor is self-powered and wirelessly connected to said annunciator module, said communication module functioning as a wireless repeater to negate an effect of a metal confined space enclosure that may restrict or attenuate an output signal level of said first gas detecting sensor within said confined space, allowing wireless data, transmitted from a wireless data source outside of said confined space.

5. The access system of claim 1 in which said entry apparatus is a ladder.

6. The access system of claim 1 in which said entry apparatus is a carrier for lowering said worker into said confined space.

7. The access system of claim 5 in which said first gas detecting sensor samples gas from a lower leg of said ladder.

8. The access system of claim 1 in which said alarm status annunciator module is mounted on an upper portion of said entry apparatus extending outside of said entrance port.

9. The access system of claim 1 in which said alarm status annunciator module is remotely located away from an active dormant module located upon said entry apparatus, and said second active dormant sensor is located within said active dormant module.

10. The access system of claim 9 wherein said active dormant module communicates wirelessly with said remotely located alarm status annunciator module.

11. The access system of claim 1 in which a video camera and integrated light are mounted on said entry apparatus within said confined space.

12. The access system of claim 6 in which said carrier is a cable based entrance assembly comprising a cable having a carrier for supporting said worker, said first gas detecting sensor attached to a bottom end of said cable below said worker, a reel assembly for lowering said cable and worker into said confined space, and said alarm status annunciator module mounted on a framework for said reel.

13. The access system of claim 1 further comprising a sensor detecting an orientational position and/or movement and/or load of said entry apparatus at or within said confined space.

14. The access system of claim 13 wherein activation of said sensor initiates interpretation of data from said first gas detecting sensor and activates annunciators indicating denial or acceptance of access into said confined space.

15. The access system of claim 1 wherein said second active dormant sensor for determining worker access is selected from the group consisting of at least one of an optical sensor, a position switch, an ultrasonic sensor, a pressure sensor, a load sensor, a conduction sensor, a Hall Effect sensor and a piezo electric sensor, or combinations thereof.

16. The access system of claim 1 having a monitoring station computer for, receiving telemetry from said annunciator module through a wireless interface and/or wired connection to provide alerts to a monitoring person outside of said confined space, said computer running software that receives and interprets said telemetry, said computer comprising at least one of a computing device capable of a network interface and running said software including but not limited to the group consisting of personal computers, mobile computing tablets, smart phones, wearable interactive devices and combinations thereof.

17. A method of preventing access to a dangerous confined space comprising the steps of:
extending an entry apparatus to facilitate entry of a worker into said confined, space through an entrance port into said confined space;
sampling gas with a first gas detecting sensor from lower portion of said entry apparatus within said confined space for detecting a dangerous condition;
using an alarm status annunciator module outside of said confined space communicating with said sensor for broadcasting whether environment within said confined space is safe or unsafe for entry by said worker; and,
providing a second active dormant sensor with feedback to monitor active access by an individual into said confined space.

18. The method of claim 17 in which said annunciator module directs power to said first gas detecting sensor and controls an on/off state of said first gas detecting sensor thereby simplifying power management of both said first gas detecting sensor and said annunciator module.

19. The method of claim 17 in which said first gas detecting sensor is powered from and with a wired data connection to said annunciator module, said annunciator module functioning as a repeater of said first gas detecting sensor data from within said confined space, allowing wireless data from a wired data source inside of said confined space.

20. The method of claim 17, in which said first gas detecting sensor is self-powered and wirelessly connected to said annunciator module, said communication module functioning as a wireless repeater to negate an effect of a metal confined space enclosure that may restrict or alternate an output signal level of said first as detecting sensor within said confined space, allowing wireless data transmitted from a wireless data source outside of said confined space.

21. The method of claim 17 in which said entry apparatus is a ladder.

22. The method of claim 17 in which said entry apparatus is a carrier for lowering said worker into said confined space.

23. The method of claim 21 in which said first gas detecting sensor samples gas from a lower leg of said ladder.

24. The method of claim 17 in which said alarm status annunciator module is mounted on an upper portion of said entry apparatus extending outside of said entrance port.

25. The method of claim 17 in which said alarm status annunciator module is remotely located away from an active dormant module located upon said entry apparatus, and said second active dormant sensor is located within said active dormant module.

26. The method of claim 17 wherein said active dormant module communicates wirelessly with said remotely located alarm status annunciator module.

27. The method of claim 17 in which a video camera and integrated light are mounted on said entry apparatus within said confined space.

28. The method of claim 22 in which said carrier is a cable based entrance assembly comprising a cable having a carrier for supporting said worker, said first gas detecting sensor attached to a bottom end of said cable below said worker, a reel assembly for lowering said cable and worker into said confined space, and said alarm status annunciator module mounted on a framework for said reel.

29. The method of claim 17 further comprising a sensor detecting an orientational position and/or movement and/or load of said entry apparatus at or within said confined space.

30. The method of claim 29 wherein activation of said sensor initiates interpretation of data from said first gas detecting sensor and activates annunciators indicating denial or acceptance of access into said confined space.

31. The method of claim 17 wherein said second active dormant sensor for determining worker access is selected from the group consisting of at least one of an optical sensor, a position switch, an ultrasonic sensor, a pressure sensor, a load sensor, a conduction sensor, a Hall Effect sensor and a piezo electric sensor, or combinations thereof.

32. The method of claim 17 in which a monitoring station computer receives telemetry from said annunciator module through a wireless interface and/or wired connection to provide alerts to a monitoring person outside of said confined space, said computer running software that receives and interprets said telemetry said computer comprising at least one of a computing device capable of a network interface and running said software including but not limited to the group consisting of personal computers, mobile computing tablets, smart phones, wearable interactive devices and combinations thereof.
